(19) United States
(12) Patent Application Publication
(10) Pub. No.: US 2020/0391555 A1
(43) Pub. Date: Dec. 17, 2020

(54) RADIAL TIRE

(71) Applicant: The Goodyear Tire & Rubber Company, Akron, OH (US)

(72) Inventor: Kiyoshi Ueyoko, Copley, OH (US)

(21) Appl. No.: 16/437,749

(22) Filed: Jun. 11, 2019

(51) Int. Cl. B60C 9/08; B60C 15/00; B60C 11/16; B60C 9/18; B60C 9/20

(52) U.S. Cl. CPC B60C 9/08; B60C 15/0081; B60C 15/0045; B60C 11/1631; B60C 2009/2077; B60C 9/2006; B60C 2009/1842; B60C 2009/1871; B60C 9/1835

(57) ABSTRACT

A radial tire includes a pair of bead cores, a carcass layer having one or more carcass plies extending from one of the bead cores to another of the bead cores, a tread portion circumferentially encircling the toroidal form of the carcass layer, and a belt structure. The belt structure includes a radially innermost main belt layer, a first, unreinforced cushion layer disposed on a radially outer side of the main belt layer, a second, unreinforced cushion layer disposed on a radially outer side of the first cushion layer, and a protective belt layer disposed between a radially outer side of the second cushion layer and a radially inner side of the tread portion. A radially outermost layer of the main belt layer has reinforcement cords with a specified diameter. The first cushion layer has a radial thickness between 0.5 and 4.0 times the specified diameter.

### FIELD OF THE INVENTION

The present invention relates to a radial tire and a method of producing the radial tire and, more particularly, to a radial tire and a method of producing the radial tire, which may be suitable for an aircraft and which may mitigate cutting of the aircraft tire by a foreign object and the like, and which may reduce weight of the radial tire.

### BACKGROUND OF THE INVENTION

A conventional radial tire, especially an aircraft radial tire, may have a large growth of a tread surface in its radial direction by high internal pressure and centrifugal force caused by high speed rotation. If the tread surface grows outward in the radial direction, tread rubber may be expanded in a circumferential direction of the tire. If the conventional tire is non-pneumatic, the large growth may be caused by only the high-speed rotation.

Generally, the conventional aircraft radial tire may be used under conditions of high internal pressure, high load, and high speed. Therefore, when the tire rides over foreign object, the aircraft radial tire may be damaged when the entire tire rides over the foreign object, e.g., so-called “enveloping properties”. When the tread rubber of the tire is expanded in the circumferential direction, a resistance force against the foreign object may be weak. Further, such trampled foreign object may easily enter the tread and thereby damage the tire.

When an amount of growth of the central portion of the tire in its widthwise direction becomes greater than opposite ends of the tire in the widthwise direction, a diameter difference of the tire may be generated. This diameter difference may cause a drag phenomenon to the rotating tire. As a result, the shoulder portion of the tread may wear sooner than the central portion of the tread thereby shortening the life of the tread and the tire. This phenomenon is called deviated wear.

In order to improve the wearing characteristics of the tread by suppressing the growing deformation thereof, to enhance the wearing characteristics of the tread, and to enhance the enveloping properties of the tread, a conventional radial tire may include a belt layer disposed between a tread rubber layer and a crown region of a carcass layer. The belt layer may include a conventional main belt layer with a wide belt ply and a narrower auxiliary belt layer with a narrower belt ply added on a radially outer periphery of the main belt layer. This structure may thus enhance belt rigidity with the auxiliary belt layer disposed on a central portion of the main belt layer. Further, this structure may restrain growing deformation of the tread central region. One conventional structure for reducing growth use of a cord with relatively high elasticity made of aromatic polyamide (e.g., Kevlar™). As compared with an aliphatic polyamide (e.g., Nylon), which is conventionally used for an aircraft tire, the aromatic polyamide cord may exhibit high tension in a low elongation percentage region and maintain the internal pressure of the tire, thereby effectively suppressing the growth of the tire.

Conventionally, reinforcing layers may include cords reinforced by glass, metal, aramid, or the like provided at an outermost layer of a belt made of organic fiber. A belt ply having higher tension may further be added. Such a layer may necessarily use a rubber thickness (thickness of rubber only with thickness of cord not included) in the tread central region where the total thickness of the belt layer becomes most thick. Rubber thickness of the tread side regions may thereby become excessively thick, thus, increasing the tire weight, increasing the heating of the tread side regions, and lowering the high-speed endurance of the tread.

In view of the above, it is an object of the present invention to provide a radial tire suitable for an aircraft in which a diameter of the tread surface is prevented from being increased during rotation, endurance against cutting occurred by foreign object or the like is enhanced, and the weight of the tire is reduced.

### Definitions

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the center plane or equatorial plane EP of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### SUMMARY OF THE INVENTION

A first radial tire in accordance with the present invention includes a pair of bead cores, a carcass layer having one or more carcass plies extending from one of the bead cores to another of the bead cores, a tread portion circumferentially encircling the toroidal form of the carcass layer, and a belt structure. The belt structure includes a radially innermost main belt layer, a first, unreinforced cushion layer disposed on a radially outer side of the main belt layer, a second, unreinforced cushion layer disposed on a radially outer side of the first cushion layer, and a protective belt layer disposed between a radially outer side of the second cushion layer and a radially inner side of the tread portion. A radially outermost layer of the main belt layer has reinforcement cords with a specified diameter. The first cushion layer has a radial thickness between 0.5 and 4.0 times the specified diameter.

According to another aspect of the first radial tire, the first cushion layer has a radial thickness between 0.5 and 2.5 times the specified diameter.

According to still another aspect of the first radial tire, the first cushion layer has an axial width between 0.5 and 1.1 times a maximum overall axial width of the belt structure.

According to yet another aspect of the first radial tire, the first cushion layer has an axial width between 0.5 and 0.9 times a maximum overall axial width of the belt structure.

According to still another aspect of the first radial tire, the second cushion layer has a radial thickness between 1.5 and 5.0 times the specified diameter.

According to yet another aspect of the first radial tire, the second cushion layer has a radial thickness between 1.5 and 3.5 times the specified diameter.

According to still another aspect of the first radial tire, the reinforcement cords of the radially outermost layer of the main belt layer have a plurality of organic fiber, merged cords.

According to yet another aspect of the first radial tire, the protective belt layer has organic fiber cords.

According to still another aspect of the first radial tire, the carcass layer has organic fiber cords.

According to yet another aspect of the first radial tire, the main belt layer has a first axial width and the protective belt layer has a second axial width, a ratio of the second axial width to the first axial width being between 0.25 and 1.20, or between 0.75 and 0.95.

A tread for a radial tire, in accordance with the present invention, includes a plurality of circumferentially extending tread grooves, one circumferentially extending center rib defined by two of the tread grooves, a radially outer surface of the center rib having a first radius of curvature, two circumferentially extending intermediate ribs defined by the tread grooves, a radially outer surface of each intermediate rib having a second radius of curvature; and two circumferentially extending shoulder ribs defined by the tread grooves. A radially outer surface of each shoulder rib having a third radius of curvature and a different fourth radius of curvature. The third radii each being disposed adjacent one of the tread grooves. The fourth radii each being disposed adjacent an axial outer edge of the tread. The second radii each being greater than the first radius.

According to another aspect of the tread, the first radius is greater than each of the third radii.

According to still another aspect of the tread, the first radius is greater than each of the fourth radii.

According to yet another aspect of the tread, the third radii are greater than each of the fourth radii.

According to still another aspect of the tread, the second radii are greater than each of the fourth radii.

A second radial tire in accordance with the present invention includes: a pair of bead cores; a carcass layer having one or more carcass plies extending from one of the bead cores to the other of the bead cores in a toroidal form; a tread portion circumferentially encircling the toroidal form of the carcass layer; and a belt structure. The belt structure has a radially innermost main belt layer, a first, unreinforced cushion layer disposed on a radially outer side of the main belt layer, a second, unreinforced cushion layer disposed on a radially outer side of the first cushion layer, and a protective belt layer disposed between a radially outer side of the second cushion layer and a radially inner side of the tread portion. The tread portion includes a plurality of circumferentially extending tread grooves, one circumferentially extending center rib defined by two of the tread grooves with a radially outer surface with a first radius of curvature, two circumferentially extending intermediate ribs defined by the tread grooves with a radially outer surface of each intermediate rib having a second radius of curvature, and two circumferentially extending shoulder ribs defined by the tread grooves. The second radii each are greater than the first radius.

According to another aspect of the second radial tire, the main belt layer has a first axial width and the protective belt layer has a second axial width, a ratio of the second axial width to the first axial width being between 0.5 and 0.90, or 0.70 and 0.90.

According to still another aspect of the second radial tire, an organic fiber cord of the main belt layer includes aramid and an organic fiber cord of the protective belt layer includes nylon.

According to yet another aspect of the second radial tire, a ratio of an axial width of the first cushion layer to a maximum axial width of the belt structure is between 0.5 and 1.1.

### BRIEF DESCRIPTION OF THE DRAWINGS

The present invention will be described by way of example and with reference to the accompanying drawings, in which:

FIG. 1 is a schematic sectional view of an example radial tire according to the present invention.

FIG. 2 is a schematic detail view of part of the radial tire of FIG. 1.

FIG. 3 is a schematic detail view of another part of the radial tire of FIG. 1.

### DESCRIPTION OF AN EXAMPLE OF THE PRESENT INVENTION

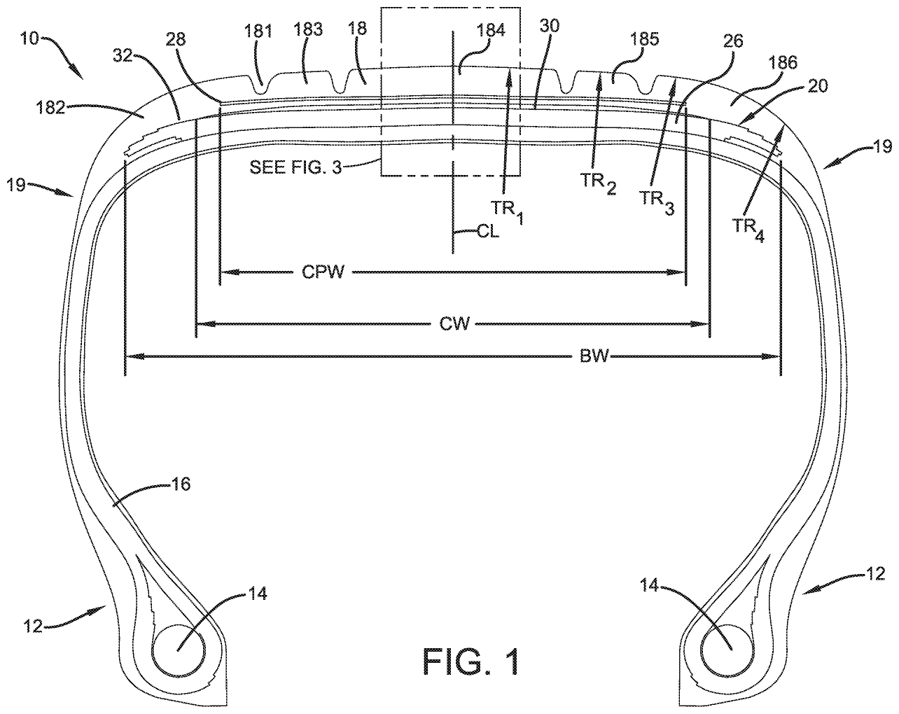

One example for carrying out the present invention will be described with reference to FIGS. 1-3 below. An example aircraft radial tire 10 may have a bead portion 12 with two bead cores 14, each having a circular cross section. A carcass layer 16 may include six or more example carcass plies (not shown) in which rubber-coated organic fiber cords may be arranged in a radial direction forming sidewalls 19 retained by the bead cores 14. Note that, since other structures, such as a flipper, a chafer, a chipper, etc. may be similar to conventional structures and are not illustrated in FIG. 1.

The carcass layer 16 may utilize an example organic fiber cord having a tensile fracture strength of 6.3 cN/dtex or higher, an elongation percentage of 0.2 to 1.8 percent when a load is 0.2 cN/dtex in the elongating direction, an elongation percentage of 1.4 to 6.4 percent when a load is 1.0 cN/dtex in the elongating direction, and an elongation percentage of 2.1 to 8.6 percent when a load is 2.9 cN/dtex in the elongating direction. The organic fiber cord of the carcass layer 16 may be an aromatic polyamide fiber with an inner-layer coefficient of 0.12 to 0.85, or 0.17 to 0.51, and an outer-layer coefficient of 0.4 to 0.85.

The carcass layer 16 may utilize another example organic fiber cord having a tensile fracture strength of 6.3 cN/dtex or higher, an elongation percentage of 0.2 to 2.0 percent when a load is 0.3 cN/dtex in the elongating direction, an elongation percentage of 1.5 to 7.0 percent when a load is 2.1 cN/dtex in the elongating direction, and an elongation percentage of 2.2 to 9.3 percent when a load is 3.2 cN/dtex in the elongating direction. The organic fiber cord of the carcass layer 16 may be an aromatic polyamide fiber with an inner-layer coefficient of 0.12 to 0.85, or 0.17 to 0.51, and an outer-layer coefficient of 0.4 to 0.85.

The organic fiber cord of the carcass layer 16 may be a merged, or hybrid, cord including aromatic polyamide fiber and aliphatic polyamide fiber. The weight ratio of the aromatic polyamide fiber and the aliphatic polyamide fiber may be from 100:27 to 100:255. Additionally, nylon may be used for part or all of the merged cord.

A belt structure 20, on a radially outer side of the carcass layer 16, may include a main belt layer 26 disposed on a radially inner side of the belt structure and a protective belt layer 28 provided on a radially outer side of the belt structure. The belt structure may have a maximum overall axial width BW. The main belt layer 26 may have a larger first axial width BW and the protective belt layer 28 may have a smaller second axial width CPW. A ratio of the second axial width and the first axial width may be between 0.25 and 1.20, or between 0.75 and 0.95.

The main belt layer 26 may be formed of a plurality of belt plies, from 2 to 16, or 8. The widths of the belt plies may be the same as each other or varying widths. The inclination angle of the organic fiber cord, or cord angle, may be between 1 and 45 degrees, or 10 and 45 degrees, with respect to the equatorial plane. The density of multiple organic fiber cords may be in a range of 4.0 cords/10 mm to 10.0 cords/10 mm, or 7.0 cords/10 mm.

The organic fiber cord(s) of the main belt layer 26 of the belt structure 20 may be a merged, or hybrid, cord including aromatic polyamide fiber and aliphatic polyamide fiber. The weight ratio of the aromatic polyamide fiber and the aliphatic polyamide fiber may be from 100:27 to 100:255. Additionally, nylon may be used for part or all of the example merged cord.

The protective belt layer 28 of the belt structure 20 may have an axial width CPW less than the axial width BW of the belt structure 20, or 0.25 BW to 1.2 BW, or 0.5 BW to 0.8 BW. The protective belt layer 28 may be formed of one or more belt plies. Additionally, the belt ply or plies 26 or the ply or plies of the protective belt layer 28 may be formed with one or more organic fiber cords coated with rubber to form band-like thin bodies wound such that, whenever the thin bodies are wound once, or 360°, the thin bodies may reciprocate between both axial ends of the plies and the thin bodies may be inclined at an angle of 0 to 25 degrees with respect to the equatorial surface, and this winding may be carried out many times while offsetting the thin bodies as substantially the same distance as their widths in the circumferential direction such that no gap is generated between the thin bodies (this is called endless zigzag-wound belt, hereinafter), as disclosed in US 2017/0253085, hereby incorporated by reference in its entirety. As a result, the organic fiber cord(s), extending in substantially the circumferential direction in a zigzag manner, may be embedded in the entire region of the belt ply or plies substantially uniformly by changing the bending direction at the both axial ply ends. The angle of the organic fiber cord(s) of the main belt layer 26 may be less than the angle of the organic fiber cord(s) of the protective layer 28.

In the protective belt layer 28, the organic fiber cord(s) may have an elastic modulus equal to or less than that of the elastic modulus of the organic fiber cords included in the main belt layer 26. Example organic fiber cords for the protective layer 28 may include an aliphatic polyamide fiber, such as nylon, or a merged cord with an aromatic polyamide fiber, such as aramid, and an aliphatic polyamide fiber, such as nylon. The protective layer 28 may include an endless zigzag-wound belt having an inclination angle of the organic fiber cord being in a range of 0 to 25 degrees with respect to the equatorial plane, or an angle of 10 degrees.

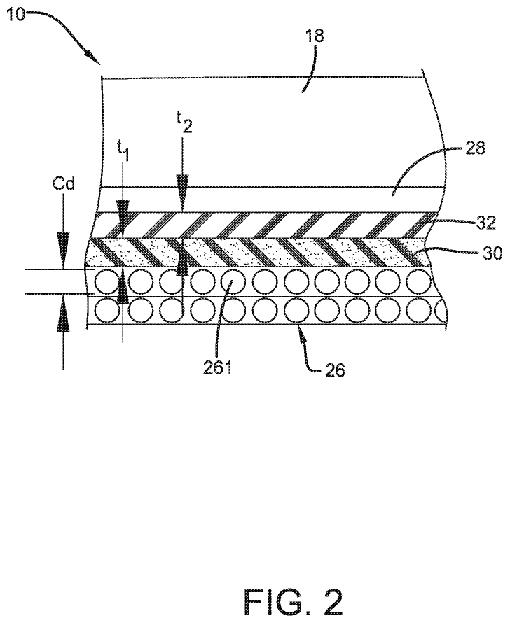

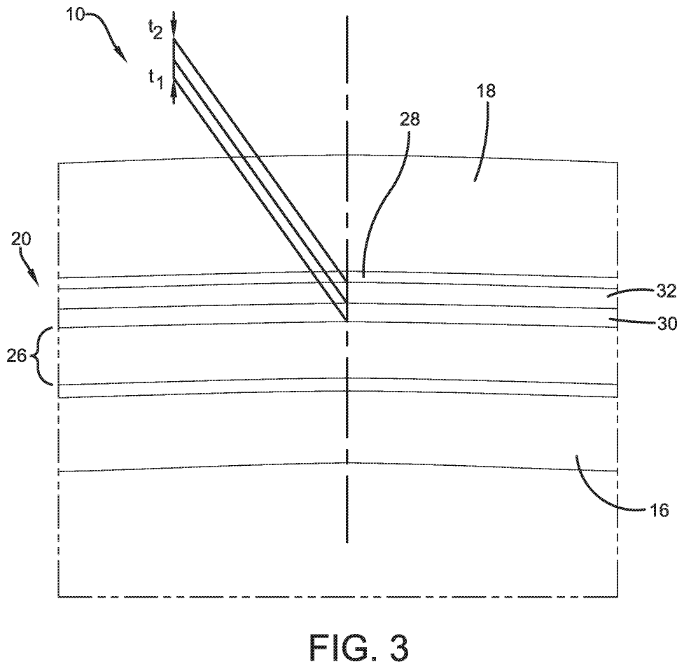

In accordance with one feature of the present invention, as shown in FIGS. 2-3, the cords 261 of the radially outermost belt ply 26 may have a uniform diameter C_{d}. The minimum thickness t₁ of a first, unreinforced (e.g., lacking cord reinforcement, etc.) rubber layer 30, or first cushioning layer, radially between the cord(s) of the main belt layer 26 and a second, unreinforced rubber layer 32, or second cushioning layer, may be in a range of 0.5 C_{d} to 4.0 C_{d} or 1.0 C_{d} to 2.5 C_{d}. The first rubber layer 30 may have an axial width CW of 0.5 BW to 1.1 BW or 0.5 BW to 0.9 BW. The radial thickness of axially outer edges of the first rubber layer 30 may taper radially inward (FIG. 2). The first, unreinforced rubber layer 30 may also comprise multiple layers with an overall thickness within the above ranges. Tread buffing during tire retreading may occur at the second rubber layer 32.

The minimum thickness t2 of the second rubber layer 32 between the first rubber layer 30 and the protective layer 28 may be in a range of 1.5 C_{d} to 5.0 C_{d} or 1.5 C_{d} to 3.5 C_{d}. The second, unreinforced rubber layer 32 may also comprise multiple layers with an overall thickness within the above ranges. If the thickness t₂ of the second rubber layer 32 is too small, when retreading the tire 10, it may become difficult to remove the rubber layers 32 without damaging the radially inner main belt layer 26. Conversely, if the thickness of the rubber layers 30, 32 is too large, not only the weight of the tire 10 increases, but also heat generation of the tread layer 18 increases, which are both disadvantageous for the performance of the tire. The thickness t₂ of the second rubber layer 32 may allow removal of the protective layer 28 during retread operations.

In accordance with another feature of the present invention, as shown in FIG. 1, the tread layer 18 may include circumferentially extending tread grooves 181 separating two circumferentially extending shoulder ribs 182, 186, two circumferentially extending intermediate ribs 183, 185, and one circumferentially extending center rib 184. The radially outermost surface of the center rib 184 may have a radius of curvature TR₁. The radially outermost surfaces of the intermediate ribs 183, 185 may have radii of curvature TR₂. The radially outermost surfaces of the shoulder ribs 182, 186, adjacent the grooves 181, may have a radius of curvature TR₃. The radially outermost surfaces of the shoulder ribs 182, 186, adjacent the axially outer portions of the sidewalls 19, may have a radius of curvature TR₄. TR₂ may be larger than TR₁. Further, TR₂ may be larger than TR₁, TR₁ may be larger than TR₃, and TR₃ may be larger than TR₄.

The tire 10 according to the present invention has been described in detail. However, the present invention is not limited to the above example, and various modifications of the example may also apply. Numerous modifications and variations of the present invention are possible in light of the above teachings. It is therefore to be understood that within the scope of the appended claims, the present invention may be practiced otherwise than as specifically and exemplarily described herein.

Further, variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes may be made in the particular examples described which will be within the fully intended scope of the present invention as defined by the following appended claims.

What is claimed:

1. A radial tire comprising:
a pair of bead cores;
a carcass layer having one or more carcass plies extending from one of the bead cores to the other of the bead cores in a toroidal form;
a tread portion circumferentially encircling the toroidal form of the carcass layer; and
a belt structure having a radially innermost main belt layer, a first, unreinforced cushion layer disposed on a radially outer side of the main belt layer, a second, unreinforced cushion layer disposed on a radially outer side of the first cushion layer, and a protective belt layer disposed between a radially outer side of the second cushion layer and a radially inner side of the tread portion,
a radially outermost layer of the main belt layer having reinforcement cords with a specified diameter, the first cushion layer having a radial thickness between 0.5 and 4.0 times the specified diameter.

2. The radial tire as set forth in claim 1 wherein the first cushion layer has a radial thickness between 0.5 and 2.5 times the specified diameter.

3. The radial tire as set forth in claim 1 wherein the first cushion layer has an axial width between 0.5 and 1.1 times a maximum overall axial width of the belt structure.

4. The radial tire as set forth in claim 1 wherein the first cushion layer has an axial width between 0.5 and 0.9 times a maximum overall axial width of the belt structure.

5. The radial tire as set forth in claim 1 wherein the second cushion layer has a radial thickness between 1.5 and 5.0 times the specified diameter.

6. The radial tire as set forth in claim 1 wherein the second cushion layer has a radial thickness between 1.5 and 3.5 times the specified diameter.

7. The radial tire as set forth in claim 1 wherein the reinforcement cords of the radially outermost layer of the main belt layer have a plurality of organic fiber, merged cords.

8. The radial tire as set forth in claim 1 wherein the protective belt layer has organic fiber cords.

9. The radial tire as set forth in claim 1 wherein the carcass layer has organic fiber cords.

10. The radial tire as set forth in claim 1 wherein the main belt layer has a first axial width and the protective belt layer has a second axial width, a ratio of the second axial width to the first axial width being between 0.25 and 1.20.

11. A tread for a radial tire comprising:
a plurality of circumferentially extending tread grooves;
one circumferentially extending center rib defined by two of the tread grooves, a radially outer surface of the center rib having a first radius of curvature;
two circumferentially extending intermediate ribs defined by the tread grooves, a radially outer surface of each intermediate rib having a second radius of curvature; and
two circumferentially extending shoulder ribs defined by the tread grooves, a radially outer surface of each shoulder rib having a third radius of curvature and a different fourth radius of curvature, the third radii each being disposed adjacent one of the tread grooves, the fourth radii each being disposed adjacent an axial outer edge of the tread, the second radii each being greater than the first radius.

12. The tread as set forth in claim 11 wherein the first radius is greater than each of the third radii.

13. The tread as set forth in claim 11 wherein the first radius is greater than each of the fourth radii.

14. The tread as set forth in claim 11 wherein the third radii are greater than each of the fourth radii.

15. The tread as set forth in claim 11 wherein the second radii are greater than each of the fourth radii.

16. A radial tire comprising:
a pair of bead cores;
a carcass layer having one or more carcass plies extending from one of the bead cores to the other of the bead cores in a toroidal form;
a tread portion circumferentially encircling the toroidal form of the carcass layer; and
a belt structure having a radially innermost main belt layer, a first, unreinforced cushion layer disposed on a radially outer side of the main belt layer, a second, unreinforced cushion layer disposed on a radially outer side of the first cushion layer, and a protective belt layer disposed between a radially outer side of the second cushion layer and a radially inner side of the tread portion,
the tread portion including a plurality of circumferentially extending tread grooves, one circumferentially extending center rib defined by two of the tread grooves with a radially outer surface with a first radius of curvature, two circumferentially extending intermediate ribs defined by the tread grooves with a radially outer surface of each intermediate rib having a second radius of curvature, and two circumferentially extending shoulder ribs defined by the tread grooves, the second radii each being greater than the first radius.

17. The radial tire as set forth in claim 16 wherein the main belt layer has a first axial width and the protective belt layer has a second axial width, a ratio of the second axial width to the first axial width being between 0.50 and 0.90.

18. The radial tire as set forth in claim 16 wherein an organic fiber cord of the main belt layer includes aramid and an organic fiber cord of the protective belt layer includes nylon.

19. The radial tire as set forth in claim 16 wherein a ratio of an axial width of the first cushion layer to a maximum axial width of the belt structure is between 0.5 and 1.1.
